(19) United States
(12) Patent Application Publication
(10) Pub. No.: US 2016/0354960 A1
(43) Pub. Date: Dec. 8, 2016

(54) SCREW-TYPE LOW PRESSURE INJECTION MOLDING MACHINE AND METHOD OF INJECTION MOLDING

(71) Applicant: SUZHOU FLUID RESEARCH AUTOMATION CO., LTD, Jiangsu (CN)

(72) Inventor: Yaoxuan Liu, Shenzhen, Guangdong (CN)

(73) Assignee: Suzhou Fluid Research Automation Co.,Ltd, Jiangsu (CN)

(21) Appl. No.: 15/030,311

(22) PCT Filed: Feb. 11, 2015
(86) PCT No.: PCT/CN2015/072783

§ 371 Date: Apr. 18, 2016

(30) Foreign Application Priority Data
Jan. 16, 2015 (CN) 201510021623

(51) Int. Cl. B29C 45/74; B29C 45/77; B29C 45/47

(52) U.S. Cl. CPC B29C 45/74; B29C 45/47; B29C 45/77; B29C 2945/76006; B29C 2945/76183; B29K 2021/00

(57) ABSTRACT

The present invention provides a screw-type low pressure injection molding machine and a method of injection molding. The outer wall of the gun barrel includes a heating body; the upper end of the gun barrel is sealed to an upper sealing block and the side wall of the upper sealing block is interconnected to the charging barrel; a screw is provided in the sealing lip of the upper end of the sealing block; the upper end of the screw is connected to a driving device and driven by this driving device; the lower end of the screw extends into the lower end of the gun barrel and the lower end of the gun barrel is sealed to the heating device; the lower end of the gun barrel is interconnected to the rubber stock chamber formed inside of the heating device.

### BACKGROUND

Field of Invention

The present invention relates to a new screw-type low pressure injection molding machine and a method of injection molding.

Description of Related Art

High-temperature injection molding can lead to significant thermal degradation of the rubber stock. The gradual scorching of the rubber stock throughout the injection molding process yields a carbide output, resulting in discoloration of the rubber stock. Specifically, the thermal degradation of the residual rubber stock in the molding machine is aggravated by the interaction of the rubber stock with oxygen and moisture in the air for a substantial period of time, producing carbonization. Consequently, mixing the carbide into the rubber stock melting body produces blackspots on the products, as well as piercing, leakage, or blocking of glue guns. This is one of the common but apparently inevitable problems in the injection molding industry.

### SUMMARY

The present invention provides a new screw-type low pressure injection molding machine and a method of injection molding for solving the above technical problems.

The present invention adopts the following technical solution to solve the technical problems referenced above:

A screw-type low pressure injection molding machine comprising a gun barrel, of which the outer wall includes a heating body. The heating body comprises of three elements: the first-stage heating body, the second-stage heating body and the third-stage heating body. The side wall of the upper sealing block is interconnected to the charging barrel. A screw is provided in the sealing lip of the upper end of the sealing block. The upper end of the screw is interconnected to and impelled by a driving device. The lower end of the screw extends into the lower end of the gun barrel, which is sealed to a heating device. The lower end of the gun barrel is connected to the rubber stock chamber formed inside of the heating device. One side of the heating device is provided with the first pressure sensor. The sampling terminal of the first pressure sensor extends into the rubber stock chamber. The heating device is further provided with a discharge hole, which is interconnected to the rubber stock chamber. One side of the discharge hole is provided with a charge hole, which is interconnected to the rubber hose connecting hole located at the lower side of the heating device. The driving device and the first pressure sensor are both connected to a controller.

In the preferred embodiment, the charge hole is interconnected to the reflux valve located at the opposite side of the charge hole; the reflux valve is interconnected to the rubber stock chamber through the reflux path; and the reflux valve is connected to a reflux valve cylinder.

In the preferred embodiment, the second pressure sensor is located at one side of the heating device; the sampling terminal of the second pressure sensor extends into the rubber hose connecting hole; and the second pressure sensor is also connected to the controller.

In the preferred embodiment, the heating device comprises a plurality of heating strips, which are separately located in the plurality of through-holes throughout the heating device.

Preferably, eight through-holes are provided, which are uniformly located at one side of the heating device.

In the preferred embodiment, the heating device is an integral aluminum block.

In the preferred embodiment, the sealing fins are located at the joint between the gun barrel and the heating device. The sealing fins are also located at the joint between the gun barrel and the upper sealing block.

An injection molding method adopts the above new screw-type low pressure injection molding machine, and comprises the following steps:

Charging: the rubber stock particles are fed into the gun barrel through the charging barrel. The driving device connected to the upper end of the screw impels the screw to rotate, causing the rubber stock particles to move downwards into the rubber stock chamber through the screw thread.

Heating: the first-stage heating body, the second-stage heating body and the third-stage heating body on the outer wall of the gun barrel heat the rubber stock particles separately so as to plasticize them. Subsequently, the heating device heats the rubber stock in the rubber stock chamber.

Sensor Control: the first pressure sensor monitors the pressure in the rubber stock chamber in real-time and transmits pressure sensor data to the controller. Importantly, there is a fail-safe feature included in the invention to ensure that the pressure levels remain within an acceptable range. Specifically, if the pressure monitored by the controller is higher than the pre-set maximum value, the controller automatically transmits an order to the driving device to stop rotating and charging. Alternatively, if the driving device ceases to rotate and charge due to pressure levels that are lower than the pre-set minimum value, the controller automatically transmits an order to the driving device to start rotating and charging.

Pumping and Injecting: the rubber stock is pumped from the rubber stock chamber through the discharge hole. The rubber stock is then injected through the charge hole. Therefore, the rubber stock move from the rubber hose connecting hole into the next processing step.

In the preferred embodiment, the first-stage heating body, the second-stage heating body and the third-stage heating body are each capable of separating the gun barrel into the first heating section, the second heating section and the third heating section. Additionally, the rubber stock successively alters its composition throughout the three referenced heating sections. Specifically, in the first heating section, the rubber stock in the gun barrel is in a particle state. In the second heating section, the rubber stock is in a semi-molten state. Finally, in the third heating section, the rubber stock is in the molten state.

Additionally, the rubber stock flows into the rubber stock chamber through the reflux path when the rubber stock reflows from the rubber hose connecting hole into the reflux valve, and the reflux pressure is increased to flush the reflux valve.

Accordingly, the present invention provides several advantages. Particularly, the multi-stage heating bodies separate the gun barrel into three-stage temperature control areas so as to allow the rubber stock in the upper stage to present in a particle state and the rubber stock in the lower stage to present in a liquid state, thereby preventing the liquid rubber stock from reflowing.

Additionally, the automated fail-safe features referenced above reduce the problems associated with the rubber stock being carbonized in excessively high temperature settings. Specifically, the actual pressure value monitored by the first pressure sensor can be compared with the pre-set standard pressure value. If the actual pressure is lower than the standard pressure value, the controller directs the driving device to rotate the upper portion of the screw and feed the rubber stock into the rubber stock chamber. This process prevents the small amount of residual rubber stock in the rubber stock chamber from carbonizing in the high temperature environment. Moreover, the automated fail-safe process can prevent the device from stopping if the rubber stock cannot flow quickly enough. Therefore, the rubber stock can flow freely through the reflux valve

### BRIEF DESCRIPTION OF THE DRAWINGS

The present invention can be further detailed according to the following drawings and embodiments.

FIG. 1 is a three-dimensional diagram of the embodiment in the present invention.

FIG. 2 is a front view of the embodiment in the present invention.

FIG. 3 is the sectional view of the D-D side in FIG. 2.

FIG. 4 is the sectional view of the B-B side in FIG. 2.

FIG. 5 is the sectional view of the A-A side in FIG. 2.

FIG. 6 is another three-dimensional diagram of the embodiment in the present invention.

### MARKING INSTRUCTION OF THE DRAWINGS

1—Charging Barrel, 2—Gun Barrel, 3—Upper Sealing Block, 4—Driving Device, 5—Screw, 6—Heating Device, 7—Reflux Valve Cylinder, 8—The First Pressure Sensor, 9—The Second Pressure Sensor, 10—Discharge Hole, 11—Charge Hole, 12—Sealing Fin, 13—Rubber Stock Chamber, 14—Rubber Hose Connecting Hole, 15—Reflux Valve, 16—Reflux Path, 17—Rubber Pump, 61—Through-hole

### DETAILED DESCRIPTION

To clearly expound the present invention or the technical solution, the drawings are hereinafter combined to illustrate the present invention. The drawings are simplified schematic diagrams, which are only used to explain the basic structure of the present invention. Therefore, the drawings merely show the structure related to the present invention.

The detailed embodiments of the screw-type low pressure injection molding machine and the injection molding methods of the present invention are provided in the following.

### Embodiment 1

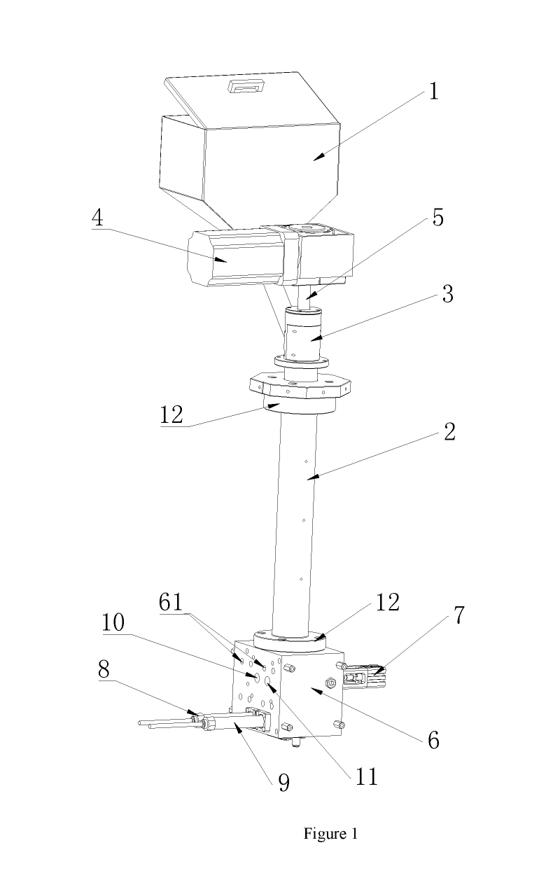

As shown in FIG. 1, the screw-type low pressure injection molding machine in the present invention comprises the gun barrel 2. The outer wall of the gun barrel 2 is provided with a heating body. The heating body comprises the first heating body, the second heating body and the third heating body (the three heating bodies are not shown in the drawing). The first-stage heating body is preferably located approximately near the upper part of gun barrel 2; the second-stage heating body is preferably located approximately in the central part of gun barrel 2; and the third-stage heating body is preferably located approximately in the lower part of gun barrel 2. The heating temperature is preferably increased in gun barrel 2 gradually from the first-stage heating body to the third-stage heating body, i.e. the first-stage heating body will comprise the lowest temperature and the third-stage heating body will comprise the highest temperature.

The first-stage heating body, the second-stage heating body and the third-stage heating body can include regular electric heating plates or other regular heating elements. The multi-stage heating bodies are arranged to separate the gun barrel 2 into three sections of temperature control areas, including the following: Section A, consisting of a low temperature area wherein the rubber stock presents in a particle state; Section B, consisting of a medium temperature area wherein the rubber stock presents in a semi-molten state; and, Section C, consisting of a high temperature area wherein the rubber stock presents in a molten state. This arrangement enables the rubber stock to be in a particle state in the upper stage and liquid state in the lower stage, thereby preventing the liquid rubber stock from reflowing.

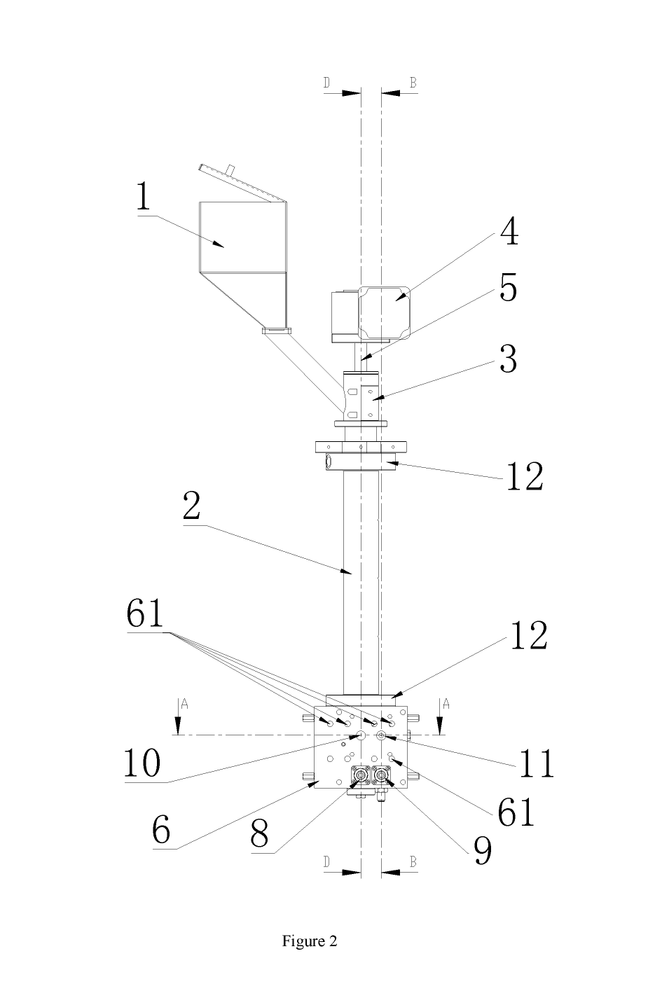

As shown in FIG. 2, the upper end of the gun barrel 2 is sealed to the upper sealing block 3 as shown in FIG. 2, the side wall of the upper sealing block 3 is connected to the charging barrel 1, enabling the rubber stock in the charging barrel 1 to enter the gun barrel 2 through the upper sealing block 3. A screw 5 is provided in the sealing lip of the upper end of the sealing block 3, and the upper end of the screw 5 is connected to the driving device 4 and impelled by the driving device 4. The driving device 4 is preferred to be a motor. The lower end of the screw 5 extends into the lower end of the gun barrel 2. The lower end of the gun barrel 2 is sealed to the heating device 6. The lower end of the gun barrel 2 is connected to the rubber stock chamber 13 formed inside of the heating device 6. The rubber stock can be fed into the rubber stock chamber 13 through the gun barrel 2.

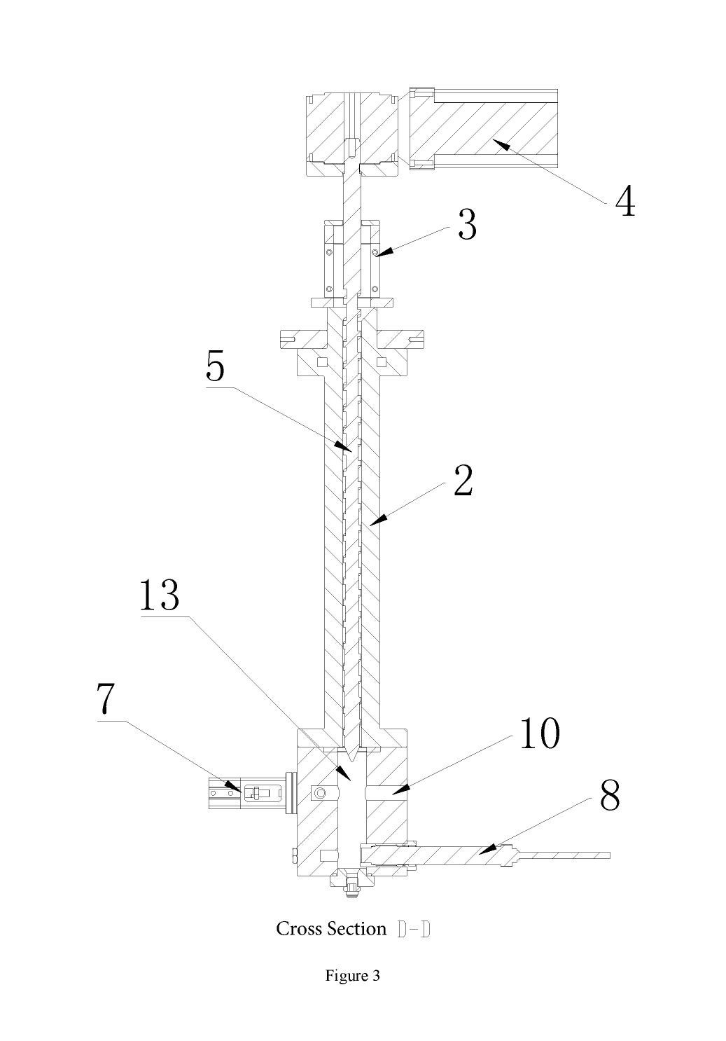

As shown in FIG. 3, one side of the heating device 6 includes the first pressure sensor 8. The sampling terminal of the first pressure sensor 8 extends into the rubber stock chamber 13. The heating device 6 also includes a discharge hole 10, which is interconnected to the rubber stock chamber 13. One side of the discharge hole 10 is provided with a charge hole 11, which is interconnected to the rubber hose connecting hole 14 located at the lower side of the heating device 6. The discharge hole 10 is interconnected to the rubber stock chamber 13.

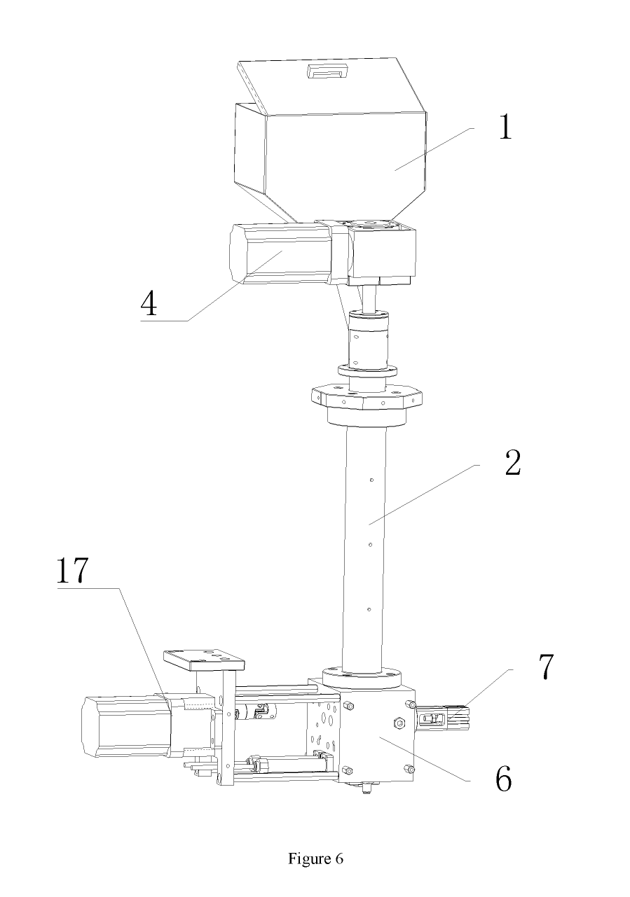

As shown in FIG. 6, it is preferred to pump the rubber stock from the discharge hole 10 through the rubber pump 17, then feed the rubber stock into the charge hole 11. Subsequently, the rubber stock is fed into the mold cavity through the rubber hose that connects hole 14 and the rubber hose by a glue gun. The rubber pump 17 can be used to increase the pressure (different products require different pressure levels). The driving device 4 and the first pressure sensor 8 are both connected to a controller. The rubber pump 17 is preferably connected to the controller, and the pressure can be increased according to the pre-set value in the controller. When the quantity of the rubber stock in the rubber stock chamber 13 increases gradually, the internal pressure in the rubber stock chamber 13 also increases gradually. The actual pressure value monitored by the first pressure sensor 8 can be compared with the pre-set standard pressure value in the controller. To avoid the negative effects of excessive pressure on the injection molding process due to the continuous charging in the rubber stock chamber, the controller directs the driving device 4 to stop rotating and charging when the actual pressure reaches the standard pre-set pressure value.

When the rubber stock is pumped from the rubber stock chamber 13, as shown in FIG. 2, the actual pressure value monitored by the first pressure sensor 8 can be compared with the pre-set standard pressure value in the controller. When the actual pressure is lower than the standard pressure, the driving device 4 is controlled by the controller to rotate and feed the rubber stock into the rubber stock chamber 13 and prevent a small amount of residual rubber stock in the rubber stock chamber 13 from carbonizing in high temperature environment, which prolongs the carbonation time and the carbonization problem of the rubber stock can be improved. Moreover, it can avoid stopping the machine when the rubber stock cannot be fed in time.

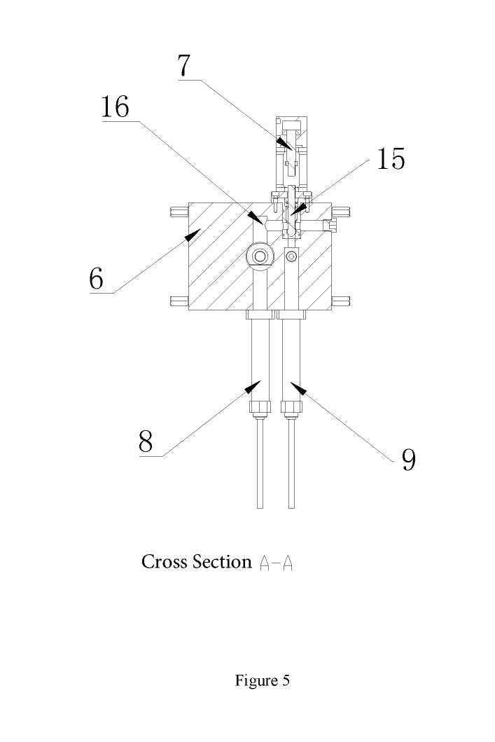

FIG. 5 shows the preferred embodiment, in which the charge hole 11 is interconnected to the reflux valve 15 at the opposite side; the reflux valve 15 is interconnected to the rubber stock chamber 13 through the reflux path 16; the reflux valve is connected to the air cylinder 7 of the reflux valve 15. When the mold cavity is filled with rubber stock, it enters a pressure maintaining stage. The rubber stock reflows safely and enters the rubber hose connecting hole 14. When the reflux pressure is higher, it can flush the reflux valve 15 so that the reflowing rubber stock can enter the rubber stock chamber 13 through the reflux valve 15 and the reflux path 16. Therefore, a safe reflow of the rubber stock can be realized.

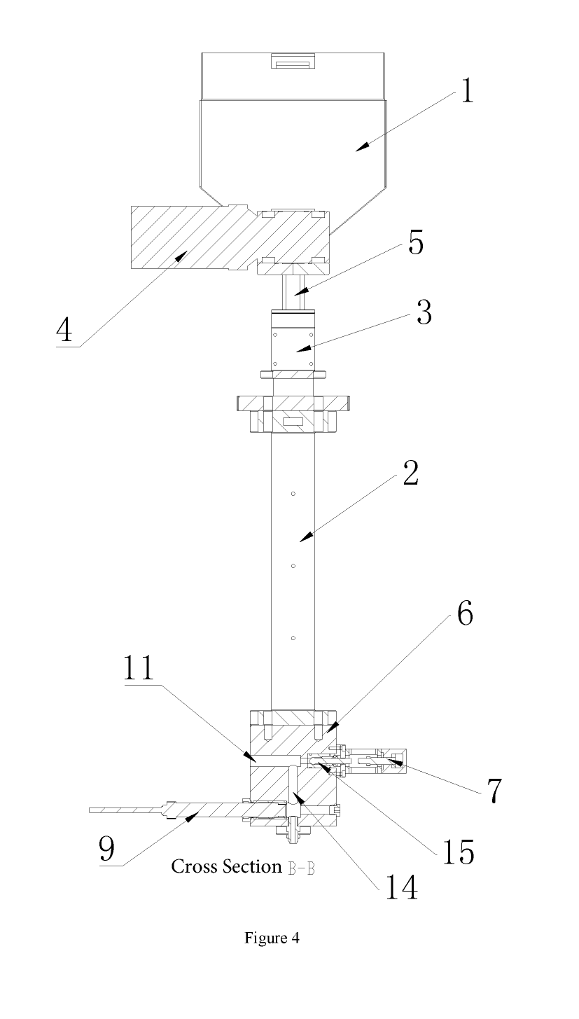

In the preferred embodiment, as shown in FIG. 4, one side of the heating device 6 is provided with the second pressure sensor 9. The sampling terminal of the second pressure sensor 9 extends into the rubber hose connecting hole 14, and the second pressure sensor 9 is connected to the controller so as to dynamically monitor the pressure in the rubber hose connecting hole 14 in real-time. The controller displays the data processed by the second pressure sensor 9. The second pressure sensor 9 monitors the discharging pressure, which is transmitted to the controller. Additionally, the reflux pressure is controlled by the controller through the atmospheric pressure proportional valve so as to stabilize the injection pressure of the rubber stock. The pressure monitored by the second pressure sensor 9 must be higher than the pressure monitored by the first pressure sensor 8 so as to produce reflow and guarantee the stabilization of rubber stock discharging.

In the preferred embodiment, the heating device 6 comprises a plurality of heating strips, which are separately provided in the through holes 61 throughout the heating device 6. A heating strip may include regular electric heating resistor strips, which are not specifically defined. The quantity of the through holes 61 and the heating strips can be determined according to requirements.

In the preferred embodiment, there are preferably eight through holes 61, which are uniformly distributed at one side of the heating device 6.

In the preferred embodiment, the heating device 6 is preferred to be an integral aluminum block because of low weight and good conductivity.

In the preferred embodiment, the sealing fins 12 are located at the joint between the gun barrel 2 and the heating device 6, as well as the joint between the gun barrel 2 and the upper sealing block 3. This arrangement ensures provides a sealing effect and minimizes the incursion of air so as to reduce the carbonization of the rubber stock.

### Embodiment 2

An injection molding method adopts the above new screw-type low pressure injection molding machine in embodiment 1, comprising the following steps:

Charging: the rubber stock particles are fed into the gun barrel 2 through the charging barrel 1 and the driving device 4 forces the screw 5 to rotate so that the rubber stock particles can move downwards into the rubber stock chamber 13 through the screw thread of the screw 5.

Heating: the first-stage heating body, the second-stage heating body and the third-stage heating body on the outer wall of the gun barrel 2 heat the rubber stock particles separately so as to plasticize them. Subsequently, the heating device 6 heats the rubber stock in the rubber stock chamber 13.

Sensor Control: the first pressure sensor 8 monitors the pressure in the rubber stock chamber 13 in real-time and transmits pressure sensor data to the controller. Importantly, there is a fail-safe feature included in the invention to ensure that the pressure levels remain within an acceptable range. Specifically, if the pressure monitored by the controller is higher than the pre-set maximum value, the controller automatically transmits an order to the driving device to stop rotating and charging. Alternatively, if the driving device ceases to rotate and charge due to pressure levels that are lower than the pre-set minimum value, the controller automatically transmits an order to the driving device to start rotating and charging.

Pumping and Injecting: the rubber stock is pumped from the rubber stock chamber 13 through the discharge hole 10. The rubber stock is then injected through the charge hole; the rubber stock moves from the rubber hose connecting hole 14 into the next processing step.

However, this sequence is unrestricted in the subsequent processing. For instance, the sensor control and charging step may occur after the pumping and injecting step due to the loss of the rubber stock. Additionally, the heating step may occur continually throughout the process to ensure the timely plasticization of the rubber stock. The other three steps can be initiated according to the requirements of the production.

In the preferred embodiment, the first-stage heating body, the second-stage heating body and the third-stage heating body are each capable of separating the gun barrel into the first heating section, the second heating section and the third heating section. Additionally, the rubber stock in the gun barrel 2 successively alters its composition throughout the three referenced heating sections. Specifically, in the first heating section, the rubber stock in the gun barrel is in a particle state. In the second heating section, the rubber stock is in a semi-molten state. In the third heating section, the rubber stock is in the molten state. The temperature in the first heating section, the second heating section and the third heating section can be adjusted according to different characteristics of the rubber stock.

The present invention preferably comprises the following step: when the rubber stock reflows from the rubber hose connecting hole 14 into the reflux valve 15 and the reflux pressure is increased to flush the reflux valve 15, the rubber stock flows into the rubber stock chamber 13 through the reflux path 16.

The description of above embodiments allows those skilled in the art to realize or use the present invention. Without departing from the spirit and essence of the present invention, those skilled in the art can combine, change or modify correspondingly according to the present invention. Therefore, the protective range of the present invention should not be limited to the embodiments above, but conform to the widest protective range which is consistent with the principles and innovative characteristics of the present invention.

1. A screw-type low pressure injection molding apparatus comprising:
a gun barrel, wherein the outer wall of the gun barrel is provided with a heating body; wherein the heating body comprises the first-stage heating body, the second-stage heating body and the third-stage heating body; wherein the upper end of the gun barrel is sealed to an upper sealing block and the side wall of the upper sealing block is interconnected to the charging barrel; wherein a screw is provided in the sealing lip of the upper end of the sealing block and the upper end of the screw is connected to a driving device and driven by this driving device; wherein the lower end of the screw extends into the lower end of the gun barrel and the lower end of the gun barrel is sealed to the heating device; wherein the lower end of the gun barrel is connected to the rubber stock chamber formed inside of the heating device;
wherein one side of the heating device is provided with the first pressure sensor and the sampling terminal of the first pressure sensor extends into the rubber stock chamber; wherein the heat device is further provided with a discharge hole, which is interconnected to the rubber stock chamber;
wherein one side of the discharge hole is provided with a charge hole, which is interconnected to the rubber hose connecting hole located at the lower side of the heating device; wherein the driving device and the first pressure sensor are both connected to a controller.

2. The apparatus of claim 1, wherein the charge hole is interconnected to the reflux valve located at the opposite side; wherein the reflux valve is interconnected to the rubber stock chamber through the reflux path; wherein the reflux valve is connected to a reflux valve cylinder.

3. The apparatus of claim 1 or 2, wherein the second pressure sensor is located at one side of the heating device; wherein the sampling terminal of the second pressure sensor extends into the rubber hose connecting hole; wherein the second pressure sensor is also connected to the controller.

4. The apparatus of claims 1-3, wherein the heating device comprises a plurality of heating strips, which are separately located in the plurality of through-holes throughout the heating device.

5. The apparatus of claims 1 to 4, wherein eight through-holes are provided to be uniformly located at one side of the heating device.

6. The apparatus of claims 1 to 5, wherein the heating device is an integral aluminum block.

7. The apparatus of claims 1 to 6, wherein the sealing fins are located at the joint between the gun barrel and the heating device as well as the joint between the gun barrel and the upper sealing block.

8. An injection molding method adopts the above new screw-type low pressure injection molding machine of any claim in 1 to 7, comprising:
Charging: the rubber stock particles are fed into the gun barrel through the charging barrel and the driving device drives the screw to rotate so that the rubber stock particles can move downwards into the rubber stock chamber through the screw thread of the screw;
Heating: the first-stage heating body, the second-stage heating body and the third-stage heating body on the outer wall of the gun barrel heat the rubber stock particles separately so as to plasticize them, afterwards, the heating device heats the rubber stock in the rubber stock chamber;
Sensor Control: the first pressure sensor real-timely monitors the pressure in the rubber stock chamber and transmits data to the controller; when the pressure monitored by the controller is higher than the pre-set maximum value, the controller transmits an order to the driving device to stop rotating and charging; when the pressure monitored by the controller is lower than the pre-set minimum value, the controller transmits an order to the stopped driving device to start rotating and charging;
Pumping and Injecting: pumps the rubber stock from the rubber stock chamber through the discharging hole then injects through the charge hole to feed the rubber stock from the rubber hose connecting hole into the next processing step.

9. The injection molding method of claim 8, wherein the first-stage heating body, the second-stage heating body and the third-stage heating body can separate the gun barrel into the first heating section, the second heating section and the third heating section; wherein the rubber stock in the gun barrel presents to be particle state, semi-molten state and molten state in the first heating section, the second heating section and the third heating section separately.

10. The injection molding method of claim 8 or 9, comprising the following step:
when the rubber stock reflows from the rubber hose connecting hole into the reflux valve and the reflux pressure is increased to flush the reflux valve, the rubber stock flows into the rubber stock chamber through the reflux path.
